(19) United States
(12) Patent Application Publication
(10) Pub. No.: US 2003/0064686 A1
(43) Pub. Date: Apr. 3, 2003

(54) Data input device

(76) Inventors: Graham G. Thomason, Redhill (GB); Jonathan Farringdon, Pittsburgh, PA (US); David P. Walker, Redhill (GB)

Correspondence Address: Corporate Patent Counsel, U.S. Philips Corporation, 580 White Plains Road, Tarrytown, NY, 10591, US

(21) Appl. No.: 10/179,350

(22) Filed: Jun. 25, 2002

(30) Foreign Application Priority Data
Jun. 28, 2001 (GB) 0115822.9

(51) Int. Cl. H04B 1/38

(52) U.S. Cl. 455/90; 455/575; 455/566

(57) ABSTRACT

A data entry system includes a number of sensors (27) behind a smooth surface (26). A pointer (34), such as a finger, traces out characters on the surface (26). An interpreter (30) matches the characters traced with predetermined patterns and outputs a corresponding character. The data entry system is suitable for use in small hand-held devices such as mobile telephones. It is suitable for entering Chinese characters.

The invention relates to a data input device and method, particularly a data input device of the type that allows a variety of characters to be input.

There are a number of applications for which it is desired to be able to input any of a number of characters using a small keypad. For example a mobile telephone does not in general have room for any more than about 12 to 15 keys, but yet many mobile telephone services require text entry. In particular, the ever increasing popularity of text messaging and WAP services means that it is more and more desirable to be able to input text. The problem is even greater with character sets that have many more than the twenty six letters of the roman alphabet, such as Japanese and Chinese character sets. The buttons of the mobile phone are inadequate to cope with all twenty six letters of the Roman alphabet, let alone the two thousand Kanji of Japanese.

A large number of prior solutions have been suggested for this problem. One option is to use speech recognition to input text, but this is not particularly reliable and may require training for each user.

More common is the use of multiple button depressions to indicate the different letters of the alphabet. For example, one press of the “2” button can provide letter “a”, two presses letter “b”, three for letter “c” and so on. This text entry method is however cumbersome and slow.

A further concept that is becoming more widespread is to use single button depressions. Each button corresponds to several different letters. The ambiguity is resolved using a dictionary, possibly also by making use of a frequency tables and context information. The system however may require user input to resolve ambiguities and may sometimes produce the wrong word.

A further option is to provide a screen with a picture of a keyboard and a stylus whereby the user selects a letter by applying the stylus to the screen. This is cumbersome, especially with small screens.

There are a number of systems that use sequential button entry to input characters. For example, U.S. Pat. No. 4,724,423 describes the use of a nine digit keypad whereby different sequences of keys correspond to different letters. In this device, some pairs of keys may be input at the same time so that the sequence input is not a simple sequence of single digits, but a more complex function of single digits and pairs of digits input together. This means that data entry is complex.

A further system using primary and secondary keys is described in U.S. Pat. No. 5,793,312 to Tsubai. In this arrangement, secondary keys are used to change the meaning of the primary keys of the keypad. Again, the system is complex to use.

DE 4127288 describes a still further arrangement. The arrangement has a number of input sensors laterally spaced, each input sensor including two contacts spaced apart by spacers. The contacts are brought together by the touch of a user. A plurality of raised pins project upward from the surface to position the fingers, for example for use by the blind. A variety of sequences each starting in digit one and ending in digit seven are used to input any of a number of characters, including letters of the alphabet and various punctuation symbols and a space. One of the contacts is reserved for switching between small and capital letters.

However, this arrangement is not particularly convenient and has not been widely adopted.

A further approach is a touch pad of the kind often used as a replacement for a mouse in a portable personal computer. Such touch pads have a number of sensors arranged in an array and can detect the motion of a finger over the touch pad. However, touch pads are not cheap, in view of the large number of sensors, and the cost is significant for mobile phone applications. Also, touch pad output is at a moderately high resolution which makes character recognition complex. The large number of sensors and large variation in the form of characters traced means that the character recognition is computationally complex. It can be difficult to provide sufficient processing power, especially in small devices such as mobile telephones.

Accordingly, there remains a need for an improved data input system for inputting significant numbers of characters in a space which does not allow sufficient keys for one character to correspond to one key.

According to the invention there is provided a device for inputting data from a group of characters; comprising: a smooth surface allowing a pointer to slide unimpeded over the surface; a number of sensors, fewer than the number of characters in the group, each sensor detecting the presence of a pointer over the sensor and outputting a corresponding output signal, the sensors being arranged laterally spaced apart from one another in an array in or under the surface for detecting the movement of a pointer tracing over the surface; and an interpreter for determining on the basis of a sequence of sensor output signals which of a plurality of patterns of pointer movement are being written on the surface and outputting a corresponding symbol from the group of characters.

The pointer used to trace characters is conveniently the user's finger.

Thus, the device has a smooth surface over which a finger can easily trace out various patterns and a small number of sensors tracking the finger and outputting information as a sequence of outputs. An interpreter interprets the sequence of the sensor outputs to determine which character is being written.

The use of a smooth surface allows the finger or other pointer to be smoothly slide over the surface without needing to depress individual locations, as in conventional touch sensitive keyboards. Further, a limited number of sensors is used, which accordingly reduces the cost of the device.

The sensors may be mounted behind holes. Holes are visible, and may in some embodiments be felt by touch. Accordingly, they guide the tracing of letters by a finger.

Preferably, the sensors can detect finger movement without requiring any pressure at all. This allows easier finger movement. The sensors may be light sensitive sensors or capacitative sensors. In this way, there is no need for any pressure as the finger is slid over the surface to ease rapid and accurate character entry. The surface may have a plurality of holes and sensors may be mounted behind the holes for detecting fingers moving above the holes.

Each sensor may correspond to an individual numeral selected from a second group of characters. The term “numeral” is here used loosely to include any of a small group of characters. Generally, this small group will include the numerals 0 to 9, as well as codes, such as *, #, or other short codes. The device can operate in one of two modes. In a first mode, the interpreter may interpret characters on the basis of the sequence of output signals as the finger traces over the surface. In a second mode, individual numerals corresponding to the second group of characters may be output, each numeral being output when the corresponding sensors detects a finger depressing that output. In this way, the device according to the invention may use the same keypad for inputting numeric data, such as telephone numbers, in a conventional manner and character data, such as roman letters and punctuation symbols, by sliding a finger to trace out certain character shapes.

The invention is of particular use for data input system for inputting pictographic characters. The interpreter may interpret sequences of sensors signals as individual strokes, and may determine the character to output based on the sequence of interpreted strokes. In this way, pictographic characters may be input, especially Chinese characters and Japanese Kanji.

Preferably, there are between 9 and 15 sensors arranged as an array. By providing such a limited number of sensors, easier and more reliable character recognition is possible than in systems with a large number of sensors that accordingly allow a character to be traced in many different positions. Preferably the sensors are arranged as a numeric keypad, including sensors labelled 0 to 9, together with sensors labelled * and # if required. Additional sensors outside the array may be used to provide additional functionality.

In a particularly preferred embodiment, 9 sensors numbered from 1 to 9 are used, arranged in a 3×3 array. This provides a minimal arrangement for inputting text. Further sensors, such as 0, *, and # may be provided but not used for character recognition.

The device may have a display for displaying a matching character selected from the group of characters based on the sequence of strokes interpreted. The display may be updated as each subsequent stroke is input to dynamically display the character that best matches the stroke input.

The device may be a mobile telephone.

The device according to the invention need not be used solely to input character strings, but may be also used to input control codes to control the functionality of the device.

The invention also relates to a method of inputting data into a device using a keypad having a surface and an array of sensors detecting the presence of a pointer over the sensor, the method including: tracing a pointer over the surface; detecting in the sensors the path traced over the surface and outputting a sequence of corresponding signals; determining from the signals the number of matches of the path traced with predetermined traces corresponding to characters from a predetermined group of characters; if the number of matches is less than a predetermined number, displaying the matched characters from the predetermined group of characters; and accepting a selection input to select one of the displayed possible matched characters and outputting the selected character.

By displaying partially matched characters and allowing for their selection the system can cope with situations where the trace for one character is incorporated within another, such as an “S” within a “$” symbol.

The invention also relates to program code for causing the device to carry out the steps of the method.

For a better understanding of the invention, embodiments will now be described, purely by way of example, with reference to the accompanying drawings in which:

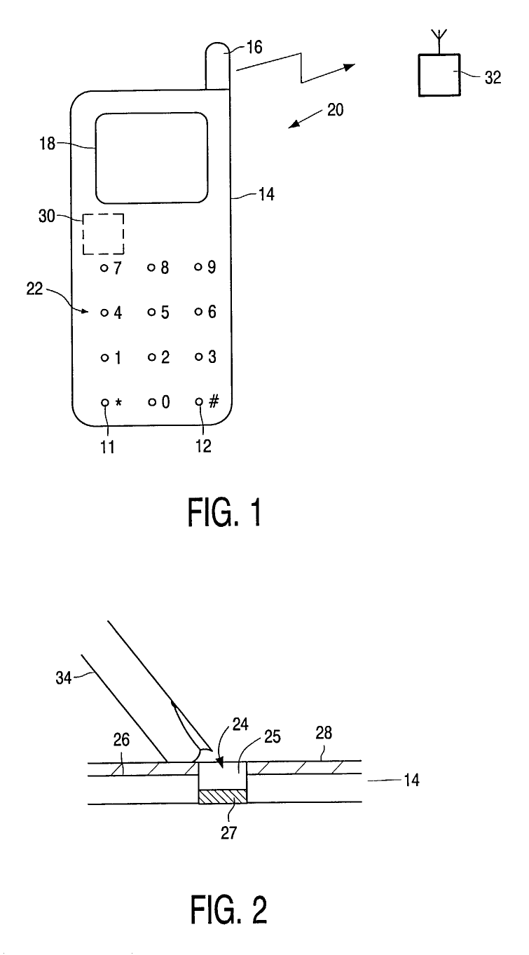

FIG. 1 shows a first embodiment of a device according to the invention;

FIG. 2 shows a cross-section through the surface of the device of FIG. 1;

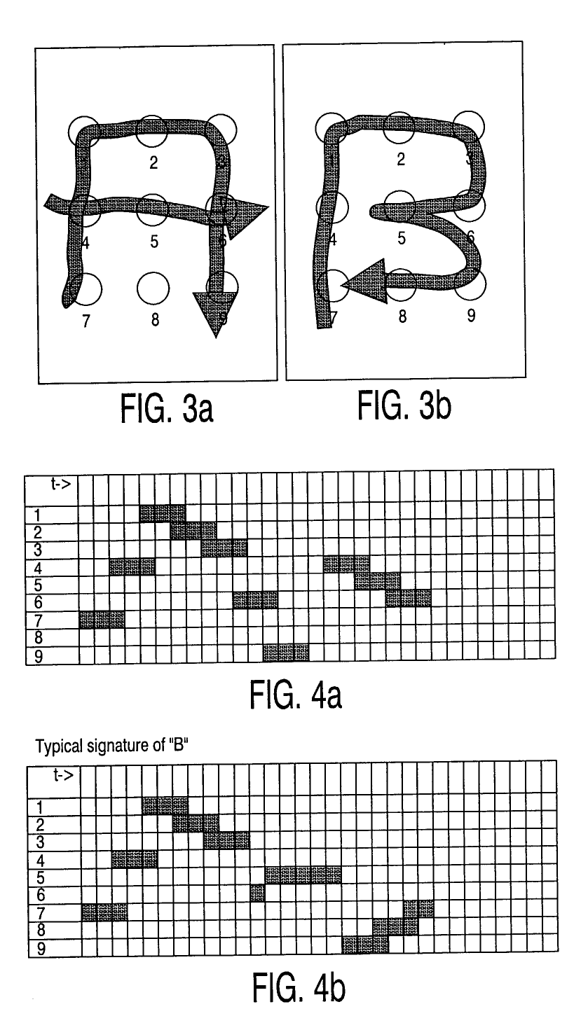

FIGS. 3a and 3b illustrate the letter patterns for the letters “A” and “B”;

FIGS. 4a and 4b show typical sensor outputs when writing “A” and “B”;

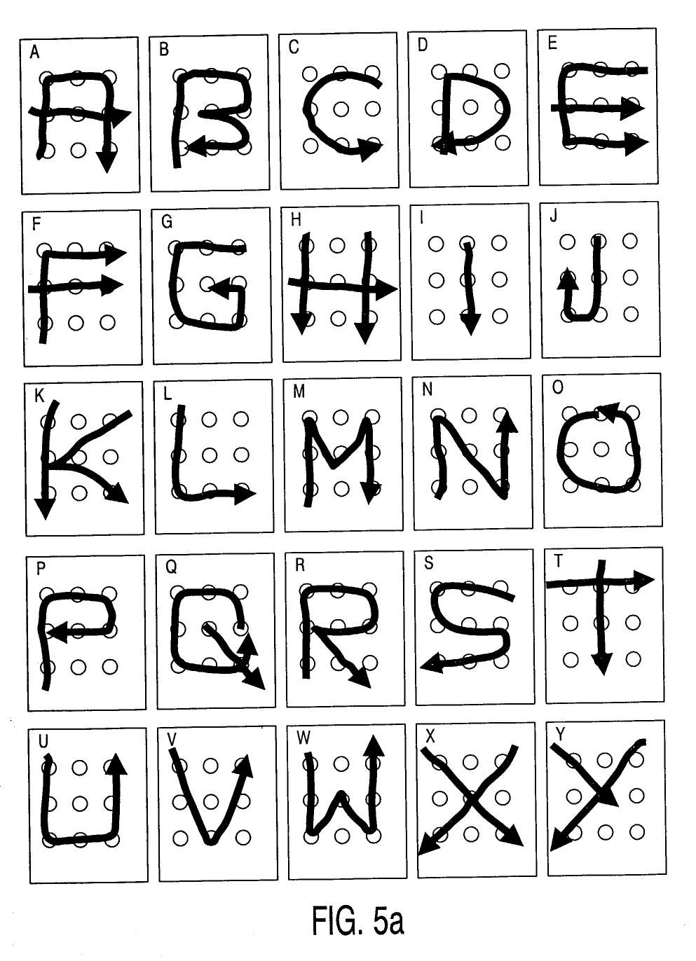

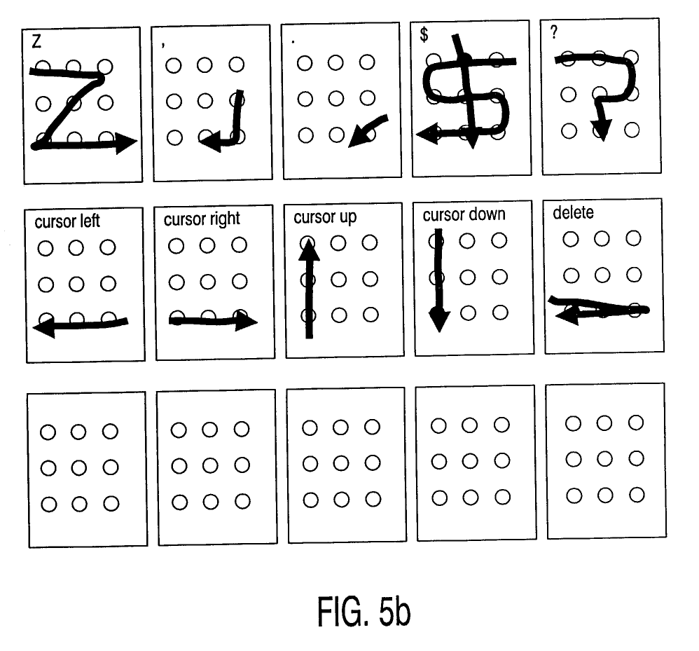

FIG. 5 illustrates possible letter patterns using an embodiment of the invention;

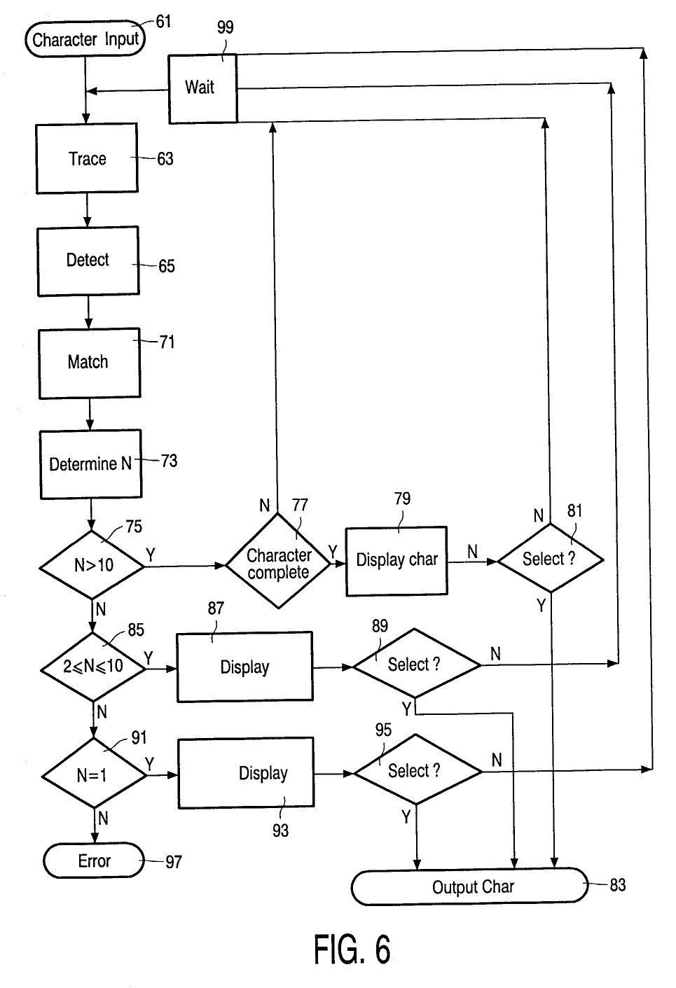

FIG. 6 is a flow diagram illustrating the method used in the first embodiment according to the invention;

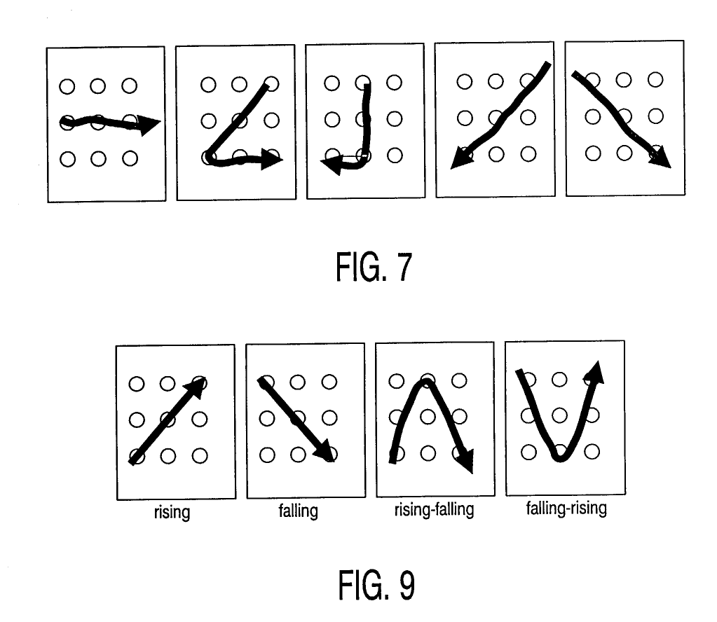

FIG. 7 is a revised flow diagram for a second embodiment of the invention;

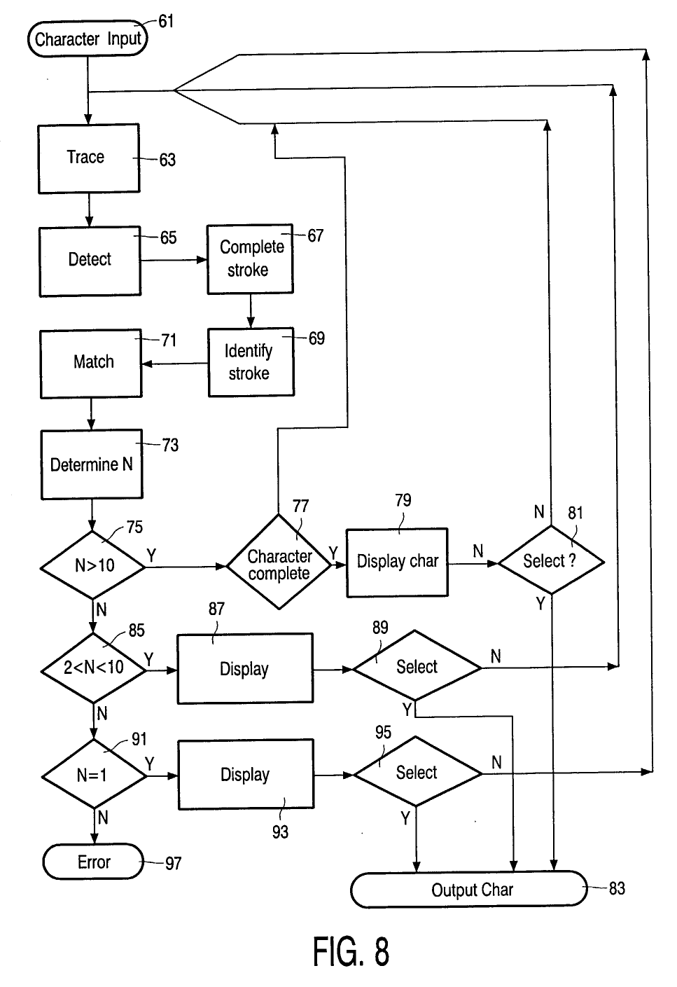

FIG. 8 shows stroke patterns detected in the second embodiment of the invention; and

FIG. 9 shows stroke patterns indicating tones.

Referring to FIG. 1, a mobile telephone 20 has a housing 14 carrying an aerial 16 and a display 18. A keypad area 22 is formed over part of the top surface of the housing, defining a plurality of holes 24. The holes 24 are labelled 1 to 9, 0, * and # (1, 2, 3 . . . 12).

The cross-section through one hole location is shown in FIG. 2 which illustrates the top surface 26 of the housing 14, the hole 24 and a sensor 27 arranged under the hole. The sensor 27 is in this embodiment a photodetector. Transparent filler 25 fills the hole 24 above the sensor. When a finger or other pointer passes over the hole 24, light is prevented from reaching the photo detector which accordingly changes its output. Alternative sensors include photo diodes or photo resistors. A capacitative sensor may also be used. All of these types of detector have the significant advantage that they do not require pressure to operate. Therefore, there is no need to maintain firm downwards pressure while tracing characters on the surface 26 of the keypad area 22.

Further, there are no projections on the surface 26 to impede motion of a finger 34 over the surface 26. This again increases the ease of writing.

In a less preferred embodiment, pressure sensors are used as the sensors.

Although the holes 24 are filled, this is not essential. In embodiments the holes 24 may be recessed below the smooth surface 26. The holes 24 are visible, so they guide the tracing of the character by the finger. The holes 24 nevertheless do not impede the tracing of characters.

The small number of sensors 27 means that there is generally only one location on the surface to trace a character, seldom more than two or three. This greatly eases character recognition compared with arrangements in which writing may be carried out anywhere on a surface such as a writing tablet or track pad.

A low friction coating 28 is provided over the surface 26 of the keypad area 22. Though not essential, this low friction coating 28, formed for example from Teflon, allows the finger to slide more easily over the surface.

The mobile telephone also includes an interpreter 30 for reading the sensor signals and interpreting them as characters. Conveniently, the interpreter may be a general purpose central programming unit connected to program memory and other memory in a manner that is well known to the persons skilled in the art, and accordingly will not be described further. In particular, the interpreter may be implemented as program code in cooperation with a central processor of the mobile telephone.

The mobile telephone communicates with a remote server 32, for example a short message service (SMS) server.

Referring to FIG. 3, the finger pattern traced to write the letters “A” and “B” are illustrated. FIG. 4 illustrates the output of sensors as the finger pattern of FIG. 3 are being written. A black square indicates that the sensor is outputting a signal, corresponding to occlusion, i.e. the time the finger is over the sensor.

Referring to FIG. 3a, the A is written by starting at sensor 7, and drawing the finger over sensors 4, 1, 2, 3, 6, and then 9. The cross of the “A” is then written by dragging the finger across sensors 4, 5 and 6. FIG. 4a illustrates the occlusion pattern that this finger dragging provides.

FIG. 3b illustrates the drawing of a “B” by starting the finger at sensor 7 and drawing the finger over sensor 4, 1, 2, 3, 6, 5 back to 6, 9, 8 and then finally ending at sensor 7. The occlusion pattern whilst this figure is being drawn is shown in FIG. 4b.

FIG. 5 illustrates the patterns traced for each of the twenty six letters of the alphabet and some control characters such as cursor left, delete, and punctuation symbols such as comma and full stop.

FIG. 6 is a flow chart illustrating the functioning of the interpreter. Normally, the mobile phone keys 1 to 9 are simply used in a numeric input mode to input corresponding numerals for dialling etc in the usual way. However, when it is required to enter text input in the mobile phone, for example for sending SMS messages, or using internet-based mobile telephony services such as WAP, a character input mode can be selected. This starts the character input program (step 61).

The user starts making a trace (step 63), which is detected by the sensors (step 65) and the corresponding pattern sent to the interpreter which makes preliminary matches of the trace of the character received so far with predetermined traces of the group of possible characters (step 71). Then the system determines how many characters are possible given the input so far (step 73). Call this number of characters N.

If N is greater than a predetermined number, say 10, determined in step 75, a test is performed (step 77) to see whether the input so far represents the complete input for any character. If not, the user must continue to enter the character. If the input does correspond to a complete character, this is displayed (step 79) for possible user selection (step 81). The user may select the character displayed or continue inputting data.

If there are at least 2 possible matches, tested at step 85, all the matches are displayed 87 for possible selection 89. The user may select one of the characters displayed or continue inputting strokes.

If there is no possible match, tested at step 91, an error message is output (step 97) and the user may start entering the character again. Otherwise, the single possible matched characters are displayed (step 93) for selection (step 95). Optionally, entering further data causes the single matched character to be selected. The new input may be treated as the start of the next character.

If the user does not select a character, the system waits 99 for a predetermined time, say 0.1 s, after the previous input before recording the occlusion pattern again. In this way, the occlusion pattern is recorded at regular intervals.

When the user selects an output, the selected character is output (step 83). This may involve adding the character to a string to be sent as an SMS message, or processed in any other way.

There are a number of variations that may be implemented by the skilled person. After the user has entered a set of inputs that may be a complete character, such as an “S”, which can either be a complete “S” or the start of a “$” symbol, the potentially complete character “S” is displayed. A user may then select the “S”, for example by actuating a predetermined sensor, for example one of the unused “O”, “*” or “#” sensors, or continue writing the character to complete the “$” symbol. Optionally, the displayed complete “S” character may be selected after a predetermined period with no further entry.

In other arrangements, the most likely character can be displayed, and continually updated as the user continues to enter the character. The character may then be selected as above.

A number of techniques may be used for the character matching. In particular, it is desirable that some deviation from the ideal pattern is still acceptable, so long as a good discrimination between characters can be maintained. Accordingly, fuzzy logic, neural networks, or hidden Markov models may all be used to carry out the pattern matching. As will be appreciated by the skilled person, the techniques are well known and so will not be described further.

Some of the characters matched may be characters that affect the functioning of the mobile telephone. For example, there may be characters provided for volume up and volume down. Any other required characters may be used as required.

The first embodiment accordingly provides a system that allows easy data entry of characters by tracing characters on a key pad that may also be used for conventional number entry.

Referring to FIGS. 7 to 9, a second embodiment of the invention, implemented in the same mobile telephone system, is used for entering large numbers of characters. In particular, the system is suitable for entering Japanese Kanji or Chinese Ideographs.

FIG. 7 illustrates the writing of the Chinese character meaning “East”. The character is made up of five strokes, illustrated, which are entered sequentially on the sensors as shown. As the user enters the strokes the best matching character is shown on the screen. The character is selected from a dictionary of characters listing the characters in order of frequency of use. If the correct character is displayed after some but not all strokes, there is no need to enter additional strokes.

Stroke patterns can be designated for each of the basic Chinese strokes.

The zero key 10 is not used for defining strokes. Instead, the zero key 10 is used for denoting the end of a character telling the system when the user has finished entering strokes for one character and is ready to enter the next.

The * (star) key 11 or the # (hash/pound) key 12 is used to request alternatives in step 89, when a plurality of options are displayed (step 87).

Referring to the flow diagram of FIG. 8, it can be seen that the method is similar to the method described with reference to FIG. 6, except that the system waits at step 67 until a whole stroke has been entered. The stroke entered is then identified (step 69). The preliminary match of step 71 then determines which characters are possible given the strokes already input, not the lower level occlusion patterns of the first embodiment. Then, the subsequent processing follows in like manner but using the strokes entered, not the occlusion patterns of the first embodiment.

If the strokes that have already been entered are a valid character in themselves, let this valid character be a complete character.

When N is more than 10 (step 75), step 77 tests whether the strokes represent a complete character. If not, the user can only continue to enter strokes. If there is a possible complete character, this is displayed (step 79) for possible user selections (step 81). The user may select to output the character (step 83) or continue to enter strokes.

If there are a moderate number of possible options, for example 2<=N<=10 (step 85), a list of possible characters is displayed (step 87). Depending on the size of display, or for other reasons, the upper limit may be varied, for example between 4 and 15. The user may then select to finish entering the character (step 89), or if not continue to enter strokes.

If N=1 (step 91) the character is displayed (step 93). Then, the user may select the complete character (step 95), or continue to enter strokes. Optionally, the entering of a new stroke may indicate selection of the character displayed and the start of a new character. This avoids the need to interrupt the tracing of strokes to select characters. In this case, an error or delete option is required.

If N=0 then the strokes must have been mis-entered, and an error message is output (step 97). Thus, if a user mis-keys, the user may enter strokes to produce an invalid character.

The step of outputting of the character (step 83) may include adding the character to a text message or sending the character to any suitable location.

In order to use the system to send SMS messages to another character the unicode number of the character may be sent. Alternatively, the phonetic equivalent may be sent. The latter approach may be used to transmit to handsets not capable of displaying Unicode Chinese characters.

Currently in Asia-Pacific countries text messages are generally sent in English using standard roman character set, perhaps building up words using three or four phonetic symbols. Another system, of the Zi corporation, assigns simple strokes to eight numeric keys. Complete Chinese characters are built up using the correct sequence of stroke keys.

In contrast, the present invention makes it possible to input all 29 Chinese strokes and build up characters in an more conventional manner.

In a further development of the invention, instead of entering strokes of a full character, the user may be allowed to enter several components or properties of characters. Suitable properties are the tones of the characters. In conventional Chinese, there are four tones, rising, falling, rising-falling and falling-rising. These tones may be entered using four traces, for example the traces shown in FIG. 9.

When several candidate characters remain, the user may select from the several possibilities of characters. This may be done by entering the tone.

Chinese characters typically consist of a radical, phonetic adornment and additional adornment. For example, the radical may have semantic value. The phonetic adornment gives phonetic value to the character, and may be another radical. The phonetic value is one of about 500 morphemes (e.g. ni, hao, ma). There are various systems for romanising the phonetic symbols.

Accordingly, to enter characters it may be possible to enter radical and tone, the phonetic value and the tone, the romanisation and the tone, or the tone and part of the full character.

Instead of only displaying possible character matches when N is less than a predetermined threshold, the threshold may be matched on fuzzy criteria. Neural networks, Bayesian reasoning, or hidden Markov chains, or fuzzy logic may be used to obtain the matching characters for selection, for example to identify those characters having a probability above a predetermined threshold.

The match to the characters may be made in a probabilistic way. Either only the most likely candidate may be displayed, or alternatively the user may be allowed to select between alternative likely candidates. By not requiring an exact character match, ease of use is improved. Nevertheless, the limited number of sensors prevents the probabilistic calculations from becoming too complex to implement in small hand-held devices.

Part of the processing may be carried out in a remote server 32. The handheld device may send semi-raw data to the remote server and receive feedback from the remote server as to the characters to display. This allows a more powerful algorithm to be run on the remote server that would not run on the more limited processing power available on the handset.

The invention is not limited to the embodiments described above and the skilled person will readily conceive of modifications.

For example, the invention is not restricted in application to a mobile telephone, but can be used in any apparatus where it is useful to input a number of characters, especially on a small keypad.

There may be alternative traces for a single letter.

The system may be arranged to learn, for each user, how the user traces the letters, rather than using unchanging patterns.

One symbol may be used to represent longer strings of text than single letters. Shortcut symbols may represent a partial or complete word, a phrase, a sentence, or any body of text.

The system may distinguish between small and large letters by their shape. Alternatively or additionally one of the keys, for example the * key or the # key, may be used as a shift key to indicate small or capital letter.

1. A device for inputting data from a group of characters; comprising:
a smooth surface allowing a pointer to slide unimpeded over the surface;
a number of sensors, fewer than the number of characters in the group, each sensor detecting the presence of a pointer over the sensor and outputting a corresponding output signal, the sensors being arranged laterally spaced apart from one another in an array in or under the surface for detecting the movement of a pointer tracing over the surface; and
an interpreter for determining on the basis of a sequence of sensor output signals which of a plurality of patterns of pointer movement are being written on the surface and outputting a corresponding symbol from the group of characters.

2. A device according to claim 1 wherein the surface has a plurality of holes and wherein the sensors are mounted behind the holes for detecting a finger moving over the surface.

3. A device according to claim 1 wherein the sensors do not require pressure to operate.

4. A device according to claim 1 having from nine to sixteen sensors arranged in the array.

5. A device according to claim 4 wherein each sensor corresponds to an individual numeral selected from a second group of characters.

6. A device according to claim 5 operable in a plurality of modes, wherein in a first mode the interpreter outputs characters from the group of characters on the basis of the sequence of output signals and in a second mode the interpreter outputs individual numerals selected from the second group of characters on the basis of individual sensor output signals.

7. A device according to claim 1 further comprising a display, wherein the interpreter is arranged to:
determine from the signals the number of matches of the path traced with characters from a predetermined group of characters;
display on the display the possible matched characters from the predetermined group of characters if the number of possible matches is less than a predetermined number; and
accept a selection input to select one of the displayed possible matched characters and output the selected character.

8. A device according to claim 1 wherein the group of characters includes at least some pictographic characters made up from a plurality of strokes, and the interpreter interprets sequences of sensor signals as strokes and determines the character to output based on the sequence of interpreted strokes.

9. A device according to claim 8 wherein the device includes a display and as a plurality of strokes is input the interpreter dynamically displays a matching character, selected from the group of characters, that matches the sequence of interpreted strokes.

10. A device according to claim 1 wherein certain sequences of sensor output signals cause the interpreter to output control codes to control the functionality of the device rather than characters selected from the group of characters.

11. A mobile telephone comprising a device according to claim 1.

12. A method of inputting data into a device using a keypad having a surface and an array of sensors detecting the presence of a pointer over the sensor, the method including:
tracing a pointer over the surface;
detecting in the sensors the path traced over the surface and outputting a sequence of corresponding signals;
determining from the signals the number of matches of the path traced with predetermined traces corresponding to characters from a predetermined group of characters;
if the number of matches is less or equal to a predetermined number, the number being at least 2, displaying the matched characters from the predetermined group of characters; and
accepting a selection input to select one of the displayed possible matched characters and outputting the selected character.

13. A method according to claim 12 including
determining if the signals correspond to a single complete character;
if the signals correspond to a single complete character, displaying the character; and
accepting a selection input to select and output the complete character.

14. A method according to claim 13 including selecting the complete character if no input is received for more than a predetermined time.

15. A method according to claim 13 including displaying the single complete character even if the number of possible character matches exceeds the predetermined number.

16. A method according to claim 13 wherein, if there is only one possible matched character and that character is complete, automatically selecting the character if further sensor input is received, and treating the further sensor input as the start of a new character.

17. A method according to any of claim 12 including forwarding the sensor output to a remote server.

18. A method according to claim 12 wherein the output sequence is matched to a plurality of stroke patterns, and wherein the method further comprises building up a character from a sequence of input stroke patterns.

19. A method according to claim 18 including determining after each stroke is entered the number of possible character matches, displaying the or each possible character if there are less than a predetermined number of characters, and allowing the user to select one of the displayed characters, to create a character for output.

20. A method according to claim 12 wherein some patterns correspond to control codes and wherein when a pattern corresponding to a control code is input the functionality of the device is changed accordingly.

21. A method according to claim 12 wherein the steps of determining the number of matches includes probabilistically matching the signals with the trace of the characters to allow for some deviation in user input from the predetermined trace.

22. A computer program comprising computer program code for performing all of the steps of claim 12 when the program is run on a data processor.

23. A device having a data input for inputting data from a group of characters; comprising:
a surface;
a display;
a number of sensors, fewer than the number of characters in the group, each sensor detecting the presence of a pointer over the sensor and outputting a corresponding output signal, the sensors being arranged laterally spaced apart from one another in an array in or under the surface for detecting the movement of a pointer tracing over the surface; and
an interpreter for determining from the signals the number of matches of the path traced with predetermined traces corresponding to characters from a predetermined group of characters; if the number of matches is less or equal to a predetermined number, the number being at least 2, displaying on the display the matched characters from the predetermined group of characters; and accepting a selection input to select one of the displayed possible matched characters and outputting the selected character.
